(19) United States
(12) Patent Application Publication
(10) Pub. No.: US 2023/0289859 A1
(43) Pub. Date: Sep. 14, 2023

(54) CIRCULAR ECONOMY PLATFORM FOR ASSET RECOVERY

(71) Applicant: Hitachi, Ltd., Tokyo (JP)

(72) Inventors: Manish GUPTA, Sunnyvale, CA (US); Dipanjan GHOSH, Santa Clara, CA (US); Chandrasekar VENKATRAMAN, Saratoga, CA (US); Archana BELANI, San Francisco, CA (US); Umeshwar DAYAL, Saratoga, CA (US)

(21) Appl. No.: 17/693,080

(22) Filed: Mar. 11, 2022

(51) Int. Cl. G06Q 30/06; G06Q 30/02

(52) U.S. Cl. CPC G06Q 30/0611; G06Q 30/0283

(57) ABSTRACT

Example implementations as described herein are directed to the use of an end-to-end asset recovery platform in conjunction with historical data of a plurality of assets. In example implementations, the end-to-end asset recovery platform tracks assets throughout the use and recovery lifecycles to provide complete visibility and enable informed decision-making for stakeholders.

### BACKGROUND

### Field

The present disclosure is generally directed to asset recovery systems, and more specifically, to an integrated asset recovery platform.

### Related Art

Megatrends (including population growth and urbanization, climate change, resource scarcity, resource price volatility) are making the transition from a Linear Economy to a Circular Economy (CE) inevitable. CE is a move towards an economic system that puts environment and society first yet can provide enormous economic value. Aside from delivering the disruptive changes needed for a sustainable future, CE is creating new opportunities for businesses to enter new markets with innovative products and services, clearing the path to long-term growth.

FIG. 1 illustrates an example of an asset lifecycle. Two key tenets of CE are Product-Life Extension (e.g., extending the life of end-of-use/end-of-life products through repair, refurbishment, remanufacture), and Resource Recovery (e.g., extracting the embedded material and energy from products at technical end-of-life stage), as shown, for example, in FIG. 1. Products or assets often have technical or physical lifetimes (e.g., the time for which they can be used) that are much longer than their economic lifetimes (e.g., the time for which they are used). This creates a value-gap which translates to wastage of resources (e.g., material, energy, labor) that have gone into making the asset. In a Circular Economy, the goal is to retain the inherent value of products by utilizing a product for as long as possible and within the shorter loops of material circulation, e.g., through reuse, repair and remanufacturing. Product-life extension model, through recovery of end-of-use assets and establishing recirculation of such recovered products, is therefore the most appropriate way to achieve that goal. Further, end-of-life products should not be destined for landfills. Recovery of usable material, which can be channeled back into manufacturing is another important objective. Asset Recovery, by addressing both end-of-use and end-of-life stages of an asset, addresses the product-circulation piece of the circular economy.

FIG. 2 illustrates an example of hierarchy of few key value retention processes. Within Asset Recovery, from a product-life extension perspective, there are a number of value-retention processes. While it is common to consider value-retention processes under a broad terminology of reuse, it is misleading. FIG. 2 shows a comparison of key value-retention approaches. Each value-retention process is distinct in terms of costs involved and how it affects product lifecycle, retains material value, and generates utility for the user. Reuse and repair only extend the initial life of a product by a finite time after which disposal is needed, and hence have limited value-retention impact. Remanufacturing is the only approach that offers a full new life to the product and hence is considered in general to the be the highest form of value-retention from a CE perspective. While remanufacturing is typically high-margin, provides significant material savings and saves about 85% of energy needed to create a new product, the prevalence of remanufacturing has been limited, and may only constitute 1-3% of new manufacturing. Technologies and solutions are being developed that address these challenges and can accelerate the uptake of the value-retention processes. However, several systemic challenges exist that hinder the adoption and expansion of value retention processes such as remanufacturing. To solve the aforementioned issues, several related art implementations have been proposed.

In one example related art implementation, for remanufacturing and other Re* processes (e.g., value retention processes including Remanufacturing, Refurbishment, Repair, Reuse, and Recycle), there may be core tracking functionality and freight management. However, the core tracking functionality and freight management lacks tracking of ageing assets in field, core quality assessments, and recommendations.

In another example related art implementation, there is an ERP add-on for remanufacturing operations. However, the ERP add-on for remanufacturing operations does not address the core-acquisition part from a core quality and core return timing perspective.

In another example related art implementation, a solution may primarily cater to warranty, service contracts, but only has a small rudimentary remanufacturing add on.

In another example related art implementation, larger remanufacturers have deployed large ERP solutions, but such solutions were built for standard manufacturing, which is fundamentally different from remanufacturing. Consequently, the remanufacturers have to develop many additional components to get these to work for remanufacturing. Most importantly, the solutions seem to be missing the value-chain integration, proactive core buyback, and core quality assessments before teardown functionalities that are fundamental to addressing the challenges.

In another example related are implementation, there is an internet of things (IoT) tracking/monitoring for assets. However, the IoT tracking/monitoring does not have any asset recovery related functionality. Many manufacturers of industrial equipment have started adding IoT and sensing capabilities to their products, but their focus has been on early-lifecycle and mid-lifecycle stages of the products, with particular focus on operations and maintenance. Similarly, asset management solutions are also focused on the early-lifecycle and mid-lifecycle stages of the products. End-of-use (EOU), end-of-life (EOL) stages and disposal have been mostly an afterthought.

### SUMMARY

Example implementations described herein involve using an end-to-end asset recovery platform that tracks assets throughout the use and recovery lifecycles to provide complete visibility and enable informed decision-making for stakeholders. The end-to-end asset recovery platform addresses challenges faced by remanufacturers, and Re* providers in general, and asset owners who want to dispose late-lifecycle stage assets.

Example implementations as described herein utilize an end-to-end asset recovery method to track a plurality of assets. The asset recovery platform is an end-to-end platform, that combines several technologies (IoT, AI/Analytics/Optimization, Blockchain, Supply-Chain Optimization) that first connects the value-chain stakeholders and then comprehensively addresses asset recovery challenges across the value-chain.

FIG. 3 shows an example of the asset-use lifecycle decoupled from the asset-recovery lifecycle. For most types of assets, the asset-use lifecycle is largely decoupled from the asset-recovery lifecycle. The decoupling stems from lack of integration in the value-chain, with each stakeholder operating in siloes and engaging in point-to-point transactions. The decoupling leads to lot of inefficiencies in value-retention processes, particularly impacting processes such as remanufacturing that aim to retain a higher value. While the inefficiencies impact multiple stakeholders along the value-chain, and lead to inefficient asset recovery, the most impacted stakeholders are the remanufacturers and the asset owners.

In an example implementation of asset recovery platform, the platform connects the asset use cycle with the asset recovery cycle and leverages digital transformations to systematically address challenges experienced by stakeholders (e.g., timing and channel to dispose of aging assets or buyback pricing of aging assets). From a CE perspective, the platform enables retention and usage of embedded material and energy in assets for as long as possible through optimized value-retention processes. From a business perspective, the platform, may enhance or maximize the economic, environmental, and/or societal gain for the stakeholders such as remanufacturers and asset owners.

Aspects of the present disclosure include a method that involves creating a trusted platform configured to exchange asset information for a plurality of assets between value chain participants; maintaining asset historical data by tracking the plurality of assets throughout a lifecycle of each of the plurality of assets; providing the asset historical data to the trusted platform; creating a shared source of truth indicative of a state of each of the plurality of assets based on the trusted platform; and providing for secure transactions between the value chain participants using the shared source of truth.

Aspects of the present disclosure further include a computer program that involves creating a trusted platform configured to exchange asset information for a plurality of assets between value chain participants; maintaining asset historical data by tracking the plurality of assets throughout a lifecycle of each of the plurality of assets; providing the asset historical data to the trusted platform; creating a shared source of truth indicative of a state of each of the plurality of assets based on the trusted platform; and providing for secure transactions between the value chain participants using the shared source of truth. The computer program may be stored on a non-transitory computer readable medium and executed by one or more hardware processors.

Aspects of the present disclosure can include a system that involves means for creating a trusted platform configured to exchange asset information for a plurality of assets between value chain participants; means for maintaining asset historical data by tracking the plurality of assets throughout a lifecycle of each of the plurality of assets; means for providing the asset historical data to the trusted platform; means for creating a shared source of truth indicative of a state of each of the plurality of assets based on the trusted platform; and means for providing for secure transactions between the value chain participants using the shared source of truth.

Aspects of the present disclosure can include a system that involves at least one memory configured to store instructions; and at least one processor coupled to the at least one memory and configured to execute the instructions to create a trusted platform configured to exchange asset information for a plurality of assets between value chain participants; maintain asset historical data by tracking the plurality of assets throughout a lifecycle of each of the plurality of assets; provide the asset historical data to the trusted platform; create a shared source of truth indicative of a state of each of the plurality of assets based on the trusted platform; and provide for secure transactions between the value chain participants using the shared source of truth.

### BRIEF DESCRIPTION OF DRAWINGS

FIG. 1 illustrates an example of late-stage lifecycle of an asset.

FIG. 2 illustrates an example of hierarchy of key value retention processes.

FIG. 3 illustrates an example of an asset use lifecycle decoupled from an asset recovery lifecycle.

FIG. 4 illustrates example challenges of asset recovery and remanufacturing.

FIG. 5 illustrates an example of an integrated asset recovery lifecycle, in accordance with an example implementation.

FIG. 6 illustrates challenges addressed by the platform and benefits of the platform, in accordance with an example implementation.

FIG. 7 illustrates an example of a blockchain or distributed ledger comprising information related to an asset, in accordance with an example implementation.

FIG. 8 illustrates an example condition assessment mechanism, in accordance with an example implementation.

FIG. 9 illustrates an example asset decommissioning mechanism, in accordance with an example implementation.

FIG. 10 illustrates an example core-buying mechanism, in accordance with an example implementation.

FIG. 11 illustrates an example data layer structure of the platform, in accordance with an example implementation.

FIGS. 12a to 12c illustrate example flow diagrams that can be executed by the platform.

FIG. 13 illustrates an example computing environment with an example computer device suitable for use in some example implementations.

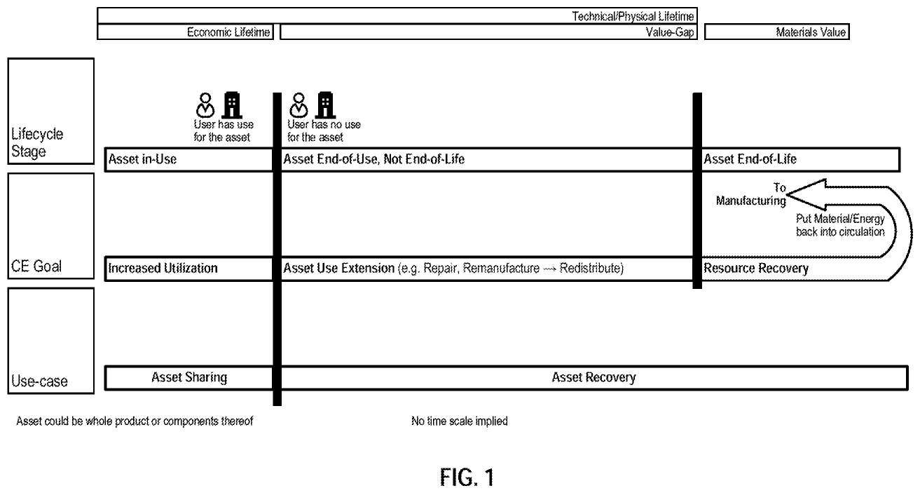

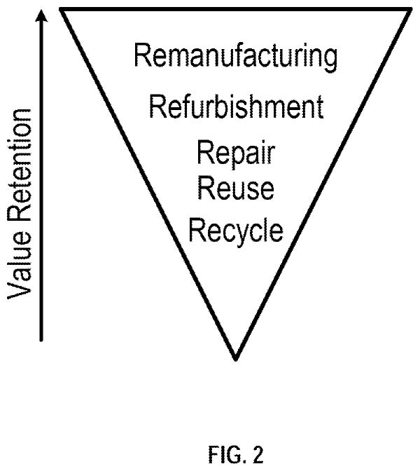

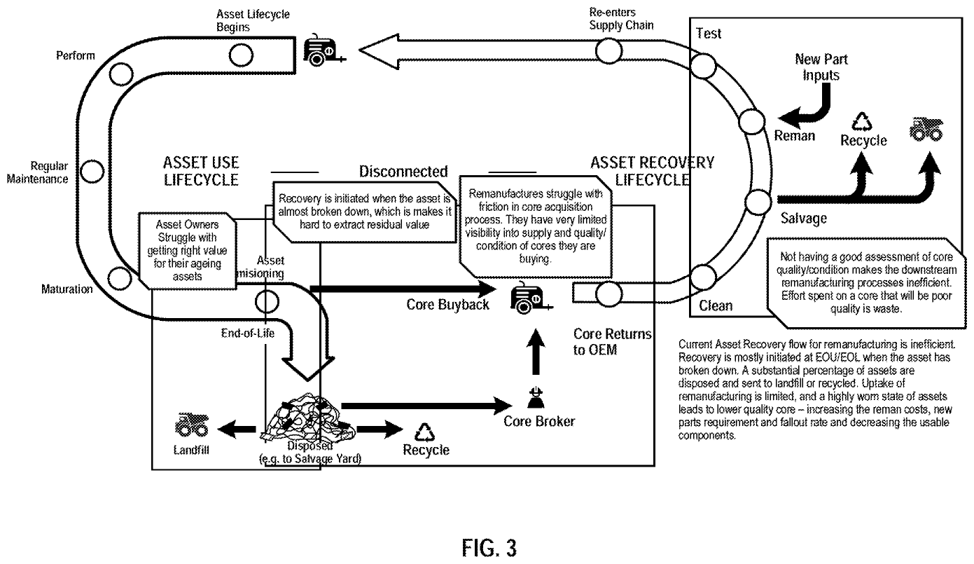

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

The disclosure is directed to an integrated connected platform for asset-recovery. The platform establishes a trusted platform underpinning to connect value-chain stakeholders and leverages analytics to reduce friction in asset recovery. It provides value to asset owners managing late-lifecycle assets, and to remanufacturers for whom such used assets form key material inputs. While the focus of the disclosure may be on facilitating remanufacturing, the platform may also support other value-retention or Re* processes (e.g., reuse, repair, refurbishment) as well. The challenges of these other Re* processes are largely a subset of those that exist for remanufacturing. Hence, while the following disclosure is from the perspective of remanufacturing, the solutions disclosed herein may also be applied/adapted to a wider set of Re* processes.

In some instances, late lifecycle industrial assets have rising operational and Maintenance Repair Overhaul (MRO) costs. Asset owners want to maximize the return when decommissioning such ageing assets. There are two primary issues: (1) uncertainty about the right timing and right channel to dispose ageing assets, and (2) uncertainty about the buyback price they should expect to get for their ageing assets.

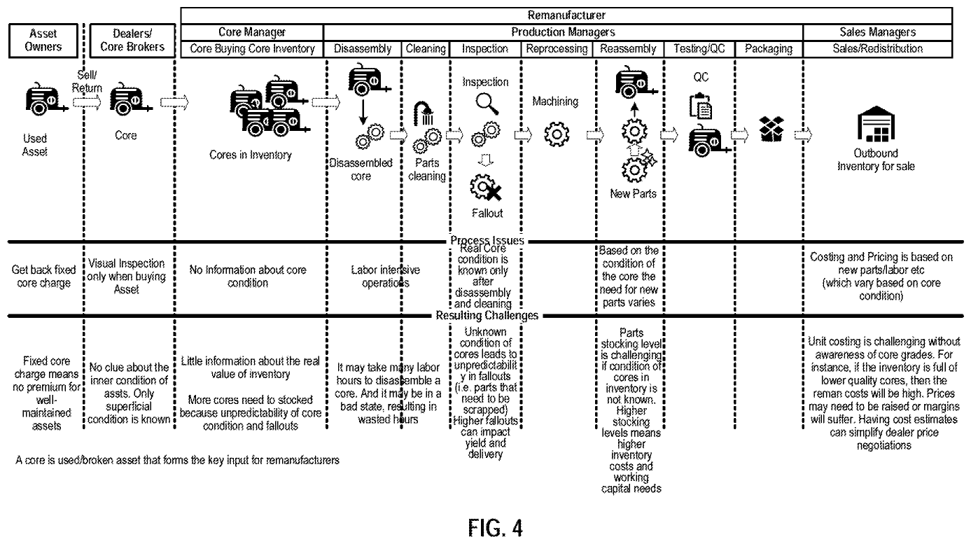

FIG. 4 illustrates example challenges of asset recovery and remanufacturing. Remanufacturers depend on recovery of used assets (also known as, “cores”) as they form the key raw material for their operations. FIG. 4 shows some of the challenges associated with asset recovery and remanufacturing processes. Some of the challenges may include, being unable to source right quantity of cores (i.e., used assets) at the right time for the right price, which may lead to a dependency on core-brokers and middlemen to acquire cores; the uncertainty about the quality/condition of cores acquired, due in part to visual inspection only being done, which is not sufficient to indicate internal condition of the asset; or the uncertainty about the quality/condition of the cores further resulting in inherent inefficiencies of the remanufacturing process. Some of the inherent inefficiencies of the remanufacturing process may include, that remanufacturing is a labor-intensive process, such that time and effort spent on disassembling/working on a core that turns out to be poor quality is a waste; part stocking levels are uncertain (e.g., a poor core will use more new parts, while a good core will use less); or that upfront costs and pricing decisions are challenging as estimations of unit costs are not available.

The integrated asset recovery platform may connect the asset use cycle with the asset recovery cycle and may leverage digital transformations to systematically address the challenges experienced by the stakeholders. From a CE perspective, the platform may prevent leakages and enable retention and usage of embedded material and energy in assets for as long as possible through optimized value-retention processes. From a business perspective, the platform may enhance or maximize the economic, environmental, and/or societal gain for the stakeholders such as remanufacturers and asset owners.

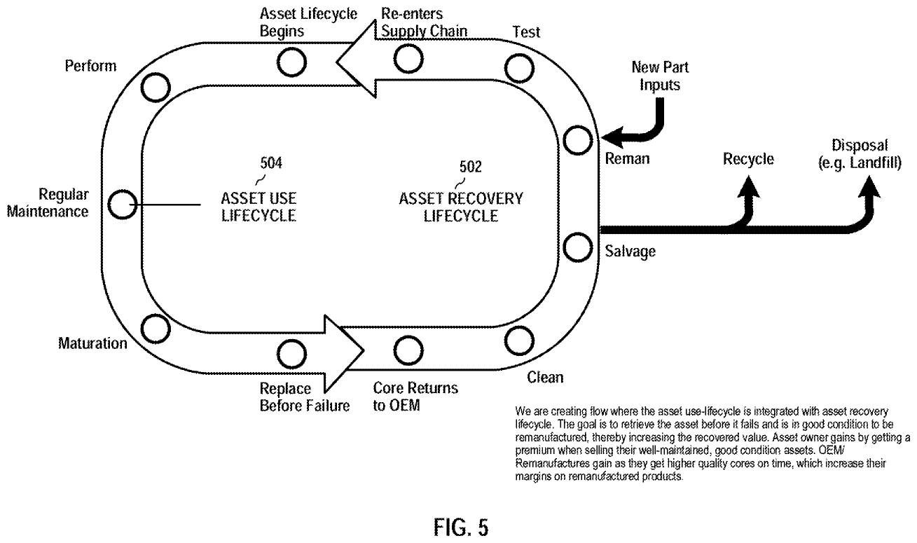

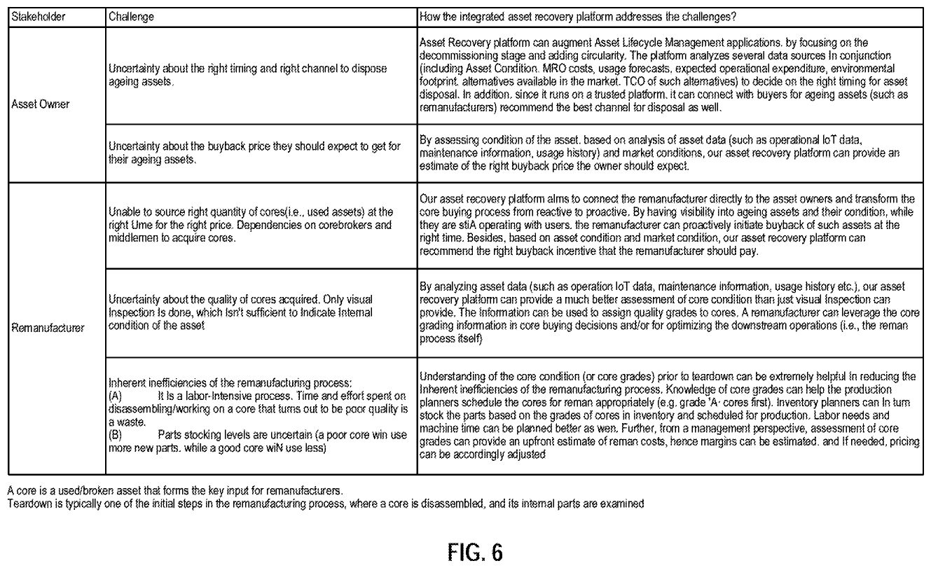

FIG. 5 provides an example of an integrated asset recovery lifecycle. For a product, the platform may enable as many such cycles as possible and viable. FIG. 6 illustrates challenges addressed by the platform and benefits of the platform. To achieve that end, the platform may initiate the asset recovery lifecycle 502 at an appropriate stage in the asset use lifecycle 504 and not wait for the breakdown or failure of the asset. Multiple stakeholders may be involved in such a product lifecycle and the ownership may change multiple times. The asset use lifecycle 504 begins when a new product is created, then it gets distributed, bought and installed by a customer, maintained by service providers, discarded at EOU/EOL. Then the asset recovery lifecycle 502 begins when the discarded asset is collected by a reverse logistics provider, processed by remanufacturer or other Re* provider into a renewed product, at which point a renewed product enters the asset use lifecycle. From a recovery point of view, the key value-chain participants are the original owner of the product and the Re* providers (e.g., remanufacturers, recyclers). However, manufacturers, distributors, parts suppliers, service providers, reverse logistics providers at EOU/EOL, redistributors, and buyers of recovered and reclaimed assets, and regulatory bodies clearly play a role in the overall lifecycle.

The asset recovery platform may be configured to provide a system that connects the stakeholders and value-chain participants in the asset recovery ecosystem to establish a trusted platform so that data and information can be exchanged by the value-chain stakeholders. The platform may enable tracking of assets through their lifecycle and enable creation of asset history. The platform may establish a shared source of truth for the stakeholders about the state of the assets. The platform may enable secure transactions between value-chain participants (such as, asset owners and remanufacturers).

The platform may also provide a system that analyzes data from assets and other sources to provide recommendations to asset owners about asset decommissioning. For example, the platform may monitor and/or analyze data for an asset to assess its condition, such as but not limited to including, remaining life, residual value, and remediation needs. The platform may utilize the condition assessment of an asset, usage information, cost estimates, availability of alternatives to recommend the right timing of disposal. The platform, for assets to be decommissioned, may identify the best options and channels for disposal by analyzing the available channels and factoring-in incentives/returns, costs, regulations, etc. The platform may also provide an estimate of buyback incentive that the asset owner should expect to get given the condition of the asset.

The platform may provide a system that analyzes data from assets in late lifecycle stages to enable proactive and informed core buying for remanufacturers. For example, for buying cores, the platform may monitor and/or analyze data for available late-lifecycle stage assets to assess their quality/condition, such as but not limited to, remaining life, residual value, and remediation needs; may use the quality/condition assessment to estimate the remanufacturing cost; may use location of the asset to estimate logistics costs; or may use the estimates of remanufacturing costs, logistics costs, market information and requirements to dynamically compute the incentives (e.g., dynamic incentives) remanufacturers need to provide to buyback the assets and recommends top buys. For the cores that have been bought, the platform may use the quality or condition assessment for optimal production scheduling by providing an estimate of labor/worker needs and machining time requirements, estimating the need for replacement parts and informing parts stocking levels, or generate costing estimates for unit level and batch level.

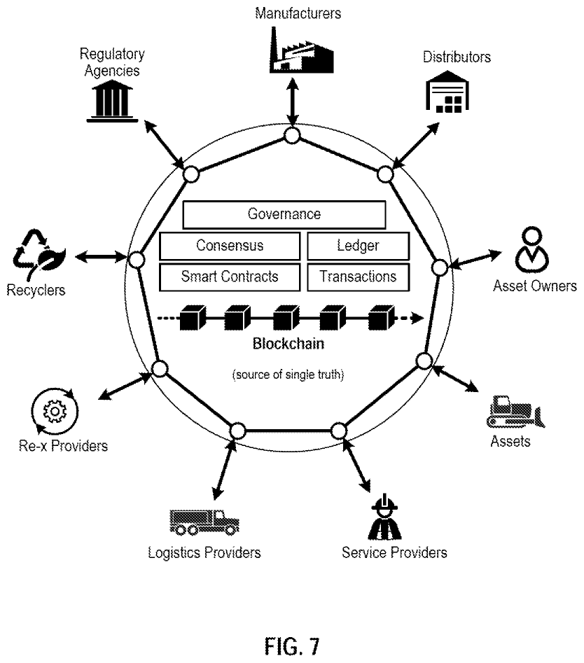

FIG. 7 illustrates an example of a blockchain or distributed ledger comprising information related to an asset. An asset, throughout its lifecycle is owned, operated, and touched by many stakeholders. Consequently, the information about it lies with many parties, each of which may be maintaining their own siloed system. It becomes difficult to have complete and shared truth about the asset. To address this issue, the trusted platform may provide a single source of truth for all the value-chain participants across a product's lifecycle. Blockchain or a distributed ledger can provide the underpinnings for such a platform, as shown for example in FIG. 7. Each participant only needs to bring information relevant for asset lifecycle management and asset recovery on to the blockchain or ledger. The other business critical data stays off-chain in independent databases. The platform not only enables secure sharing of data between participants, but provides automation of transactions, which reduces the friction in the asset recovery process.

Tracking products and sub-assemblies throughout the product lifecycle is critical as locating the product is a prerequisite to recovering the product. Changes to product configuration, replacement of sub-assemblies, and changes in ownership may be tracked and captured as a shared truth between value-chain participants to understand what can be collected from whom. Two areas for consideration include embedding asset tracking information and tracking through lifecycle.

Embedding asset tracking information may include tracking and serialization information being added to product and its sub-assemblies. Several tracking technologies exist, including barcodes, QR codes, RFID, NFC, GPS tags, each with its advantages. Tracking tags used must be tamper-proof, damage-proof and should last through the lifecycle of the product. Here we rely on tracking technology currently being used by the asset manufacturer or added by the remanufacturer during the remanufacturing of the asset.

Tracking through lifecycle may include that information related to the ownership, deployment location and usage pattern that may change during the lifecycle of an industrial equipment. Further, industrial equipment are complex products with multiple different sub-assemblies, thus having a complex Bill-of-Materials (BOM). During the lifecycle as the products undergo configurations, reconfigurations, repairs, parts replacements and maintenance, the sub-assemblies and components put in originally by the manufacturer may be changed. The sub-assemblies and components in turn may have their own circular lifecycles. Remanufacturing process itself leads to disassembly of the asset, putting constituent parts into separate bins, and then rebuilding the asset from parts from the bins and new parts. Thus, the BOM, comprised of tracking identifiers (IDs) of sub-assemblies of an asset, is changing throughout its lifecycle. Tracking the BOM of an asset throughout lifecycle in difficult due to both process and systems challenges. The trusted platform described earlier enables sharing of information. History of an asset needs to be maintained, with any changes to the constituent parts, and consequently the BOM, carefully registered in the trusted platform. This is done by providing applications that stakeholders can use to record changes. Alternatively, the platform may be integrated with systems run by stakeholders directly.

Such track and trace capability built over a trusted platform between stakeholders provides a remanufacturer visibility into late-lifecycle assets that may be operating with owners. Such visibility can include asset condition assessment as well, which can help a remanufacturer pick assets that they want to buy and optimize the incentives they need to pay for those assets to the owners. Through the platform itself, the remanufacturer can make direct offers to the owners at the right time, transforming the currently reactive process of acquiring cores into a proactive one.

The transition points within the asset lifecycle are fraught with decisions for the stakeholders. For instance, owner of an ageing asset may decide on the timing, channel (e.g., resell, remanufacture, or secondary market) to use, and needs to know the residual value when disposing of the ageing asset. A remanufacturer decides when to buy an ageing or used asset and what buyback incentive to provide for it. A buyer of assets decides if buying new or used or remanufactured makes sense for their needs. Decisions for each of these stakeholders are further complicated by multitude of factors affecting them. Improving the efficacy of the remanufacturing processes therefore requires decision-assist mechanisms that factor in available information and aid stakeholders in the informed decision-making.

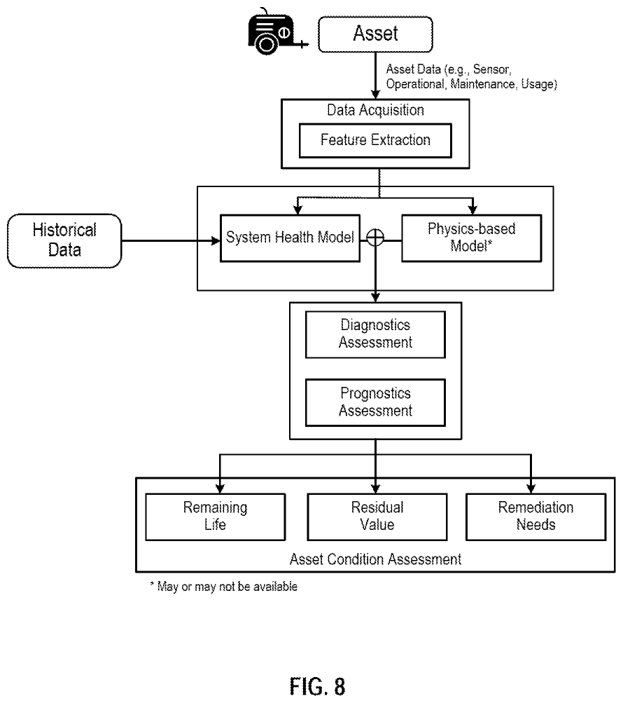

FIG. 8 illustrates an example of a condition assessment mechanism. The asset recovery platform analyzes data from multiple sources, both internal and external, structured, and unstructured, to assist stakeholders such as asset owners and remanufacturers, with such decision making. An aspect comprises an assessment of the condition of an asset and its components, estimating their remaining lives, and estimating residual values. FIG. 8 shows an example of such a condition assessment mechanism. The platform uses sensor(s), IoT, operational, and usage data from the assets, and maintenance information as the inputs. The analytics part includes historical-data based system health models or physics-based models or a combination of the two and provides both diagnostics and prognostics assessment of the asset. Such assessments can include, but are not limited to, remaining life, residual value, or remediation needs. The approach for condition assessment will be based on at least one of data availability for a particular asset class or availability of or on ability to build good analytical models. For instance, if appropriate data and system knowledge is available, Remaining-Useful-Life (RUL) estimation approaches can be used. The condition assessment needs to happen for owner of the asset (as the seller) and for the remanufacturer too (as the buyer).

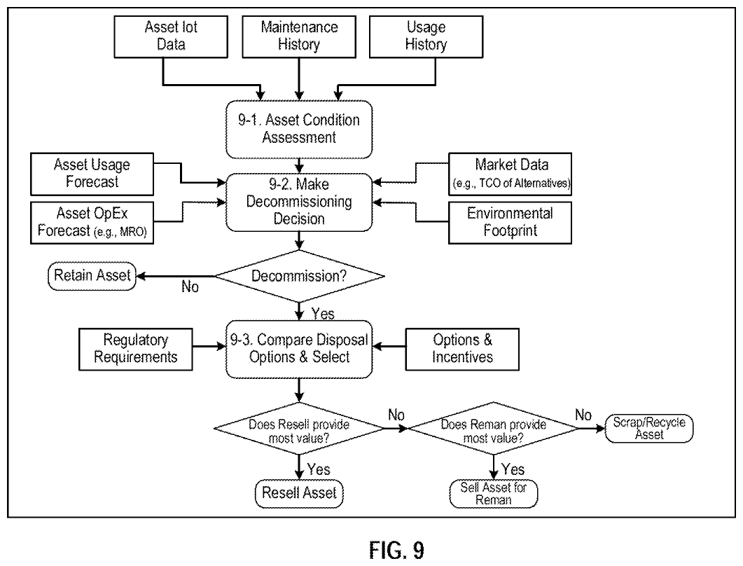

FIG. 9 illustrates an example of asset decommissioning mechanism. To an asset owner, such a condition assessment for a late-lifecycle asset will help in making decommissioning decisions, as shown for example in FIG. 9. The decommissioning decision may be based on a determination of the asset condition assessment (e.g., at 9-1) based on available datasets and the analytical models available. By combining condition assessment, with usage forecast, maintenance costs, operational costs, and environmental footprint, the system at 9-2 can compute whether the asset can meet the usage needs, and if so, at what cost. Further, by comparing with alternatives available, the system decides whether the asset should be decommissioned or not. In instances where the asset is determined to be decommissioned (e.g., at 9-3), the system can analyze available disposal options, associated incentives, and other factors (e.g., regulatory requirements) to suggest the best option for disposal and predict return/incentives they should expect to get.

Since the system runs on a connected trusted platform, sale or buy offers can be made or accepted from the platform itself and the transactions can be automated as well. It is easy to see such a component for late-lifecycle stage assets included as part of a larger asset lifecycle management system.

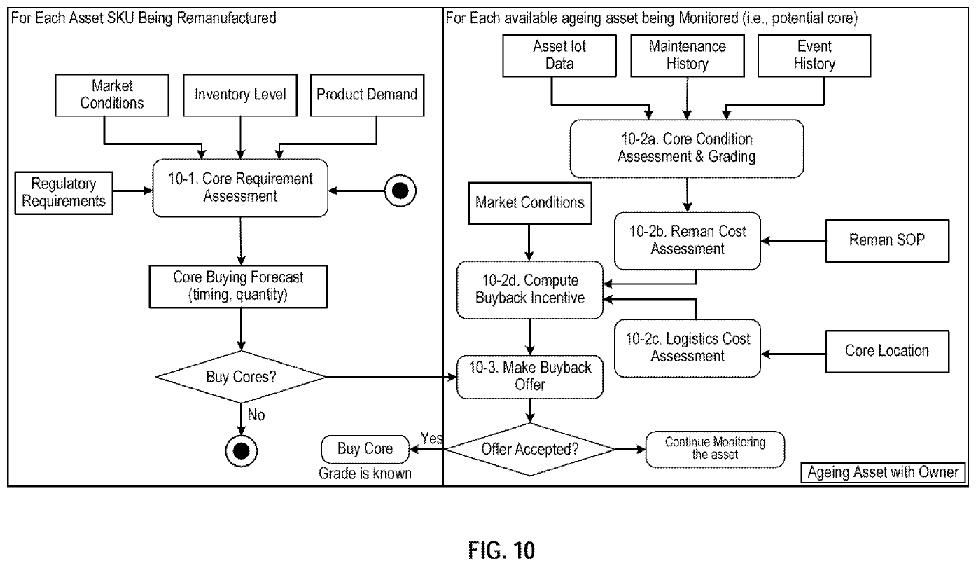

FIG. 10 illustrates an example of a core-buying mechanism. An OEM/remanufacturer who is monitoring late lifecycle stage assets in the field may use the asset recovery platform to transform the core-buying process proactive from reactive. The remanufacturer may actively track the condition of cores and make offers for right quality cores, in right quantity at the right time, as shown for example in FIG. 10. An example embodiment can have the following steps. At 10-2, periodically, for each product SKU that the remanufacturer remanufactures, the requirements for the cores is assessed. This factors in market conditions, inventory levels, demand forecasts and regulatory requirements and produces a core buying forecast with recommendations on timing and quantity of cores to buy. In parallel, for each asset that the remanufacturer is monitoring or has access to the data for, the system may, at 10-2a, assess the condition of the asset based on available data for it and assign a grade to it. At 10-2b, the system may, based on the condition/grade assessment of the asset, estimate the potential remanufacturing cost. This can be based on the standard operating procedure (SOP) that is followed for the cores of that grade or condition. At 10-2c, the system may, based on the location of the core and logistics needs, compute the estimate of logistics costs of bringing that core to the remanufacturing facility. At 10-2d, the system may, based on estimates of remanufacturing cost, logistics costs, and the current market conditions (e.g., such as prices, availability), compute the buyback incentive that can be paid to the asset owner for the core being analyzed. In some aspects, the system may create a list of top buys from the assets being analyzed. The top buys can be based on a combination of factors such as profit margins, quality of cores, or regulatory needs etc. At 10-3, if based on the forecast in 10-1, cores are to be bought, pick the assets on the top buys list created and make offers. If an offer is accepted, buy the asset. Otherwise, the remanufacturer may continue monitoring for cores.

The advantage of this proactive approach is that the remanufacturer has a good prior understanding of the quality of cores that they are acquiring. This may lead to many downstream benefits in the remanufacturing process. For example, the assessment of the condition of an asset can provide visibility to a remanufacturer into the potential remanufacturing costs and hence the margins on it. Transactionally, between the remanufacturer and the asset owner, the platform enables dynamic incentivization, based on asset condition, determining the right timing for initiating asset takeback, and estimating the incentive that can be provided to the asset owner in return for the asset. Dynamic incentivization can make core acquisition more proactive and more predictable for the remanufacturer. Asset owners will also benefit from dynamic incentivization as they stand to get a premium for assets that are in good condition that they have maintained well.

For a remanufacturer, the platform may provide improved estimates of core-quality and of core arrival-rate to vastly improve the supply forecasting for the remanufacturing operation and improve demand matching. Further, estimates of quality/condition of incoming cores and associated remanufacturing costs may streamline the downstream remanufacturing operations by significantly reducing the inherent inefficiencies. For instance, the following operations can be improved:
1. Parts estimation: remanufacturing operation may require a variable number of parts per core (e.g., based on wear and tear). In some instances, parts inventory may have a large buffer to address any unforeseen needs. This increases inventory cost and working capital needs. The platform may provide a better understanding of the condition of incoming cores which helps inform parts needs and optimize the stocking levels.
2. Worker/Labor Needs and Machining Needs: Remanufacturing is a labor-intensive operation. Each core is different, the worker/labor and machining needs vary, which makes production scheduling extremely difficult. Sometimes, many hours are spent disassembling a core only to discover that the core is largely unusable which resulting in increased fallout. The platform may provide an estimate of quality before teardown (i.e., disassembly) which may optimize production and make fallouts more predictable or reduced.
3. Financial forecasting and pricing decisions: the platform may provide information related to remanufacturing costs upfront which may improve financial forecasting for the business overall. The platform providing a better estimate of unit costs may allow for pricing decisions to be more informed.

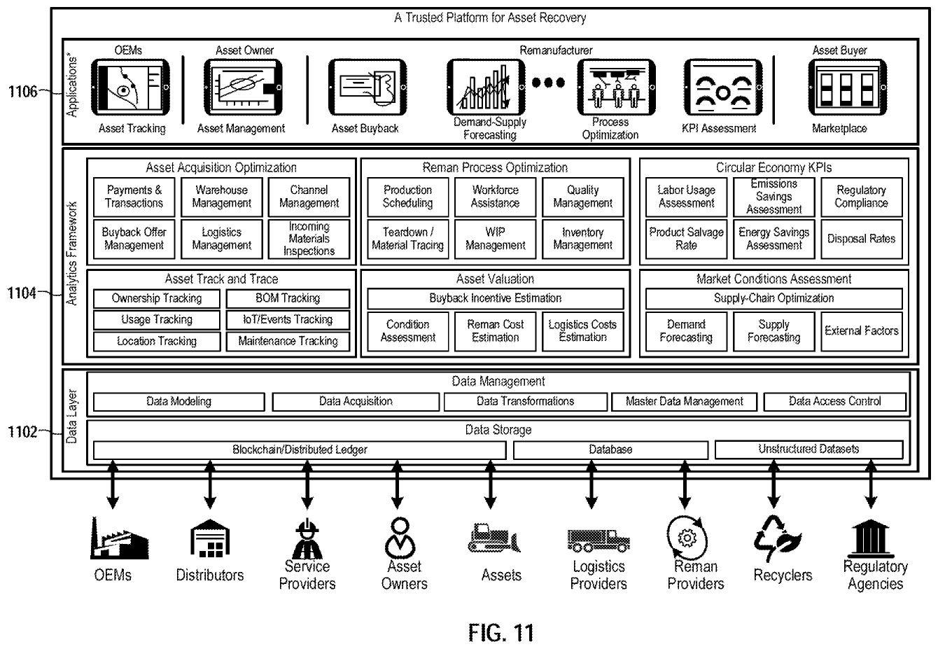

FIG. 11 illustrates an example data layer structure of the platform. Aspects of the solution described above synthesize a reference architecture for an Integrated Platform for Asset Recovery configured to transform the asset recovery processes. The architecture can be looked at in three broad layers, for example as shown in FIG. 11. At the bottom is the data layer 1102 which caters to acquisition, transformation, storage, and management of data. An aspect of the platform is to bring the value-chain participants together, and establish trust and data sharing to create a single source of truth. For this, the data layer includes a blockchain or distributed ledger. Not all data can be on blockchain and hence the data layer includes databases for structured and unstructured datasets. For larger networks, it may be necessary to keep most of the data off the blockchain in databases and only store hashes in blockchain to establish trust in data.

Analytics framework layer 1104 sits above the data layer and forms the core of the platform. The analytics framework layer includes functionality for tracking and tracing assets, assessing the condition of the assets to ascribe value to them, and managing the acquisition of those assets. It also includes functionality for market conditions assessment, demand-supply forecasting, and supply chain optimization. From a remanufacturing process perspective, it includes components to address the inherent inefficiencies of the reman process. In some aspects, functionality to measure circularity KPIs along various dimensions may be included as well. Each of these functional blocks may be customized, interpreted, designed and implemented in the specific context of an asset type and the business.

The user applications layer 1106 is at the top and may customize and provide access to the necessary functionality to each stakeholder, such as asset owners and remanufacturers. The user applications may be configured as a self-contained functional unit, with role-based access control, and are targeted towards a persona at a stakeholder.

The platform and mechanisms may be utilized for efficient recovery of assets in the end-of-use and end-of-life stages. The platform may provide the following functionalities and advantages for at least the two primary stakeholders in the recovery process (e.g., asset owners and remanufacturers). For example, the platform may provide asset owners with assistance with decommissioning decisions for late lifecycle stage assets by recommending the right timing and right channel (e.g., resell, repair, remanufacturing, recycle) for disposal. The platform may also provide asset owners with an optimization of return when disposing late-lifecycle stage assets, by calculating the right residual value and connecting asset owners with the right buyers. With regards to remanufacturers, the platform may provide visibility into available late lifecycle assets to enable proactive sourcing of cores (e.g., used assets). The platform may also provide remanufacturers with an assessment of quality/condition of used assets and using the assessment to improve the estimate their residual value, cost of remanufacturing, and the buyback incentive the remanufacturer can provide to asset owners. The platform allows for the use of quality assessments which may optimize the downstream remanufacturing operations—such as optimization of parts-levels that need to be maintained, better production scheduling, and better forecasting of unit costs and pricing of remanufactured products.

The platform may be applied in multiple different ways. For example, in short term instances, the platform may be offered as an asset recovery solution to an manufacturers that may use the platform for forward integration of their value-chains beyond the equipment sales. The platform may be used for multiple applications. For example, the platform may track their products through the lifecycle. In some regions, stringent environment laws may be enacted and climate resolutions may come into force, such that manufacturers are increasingly required to be responsible for the whole asset lifecycles. In some instances, the platform may institute or optimize an integrated remanufacturing business for their products. As products are getting increasingly commoditized and globalization is making lower-cost alternatives abundantly available, remanufacturing may allow manufacturers to provide lower cost alternatives to customers, without compromising quality or brand value. In some instances, the platform may transform the relationships with customers from passive transactions to be proactive relationships. The platform may enable value-retention processes that provide greater value-realization to customers over the life of the assets. The platform may augment an enterprise asset management solution, by making it circular. Most asset management solutions are fairly linear such that they are focused on early- and mid-life stages of an asset, essentially the procure, commission, operate, decommission stages. The platform may complement an asset management solution, by improving the decommissioning functionality and adding to the post-decommissioning stages (e.g., recovery, Re-* and redistribution) thereby making the whole process circular.

In long term instances, the platform may be used as the basis for Asset Recovery marketplace, which may be run independently or in collaboration with an established marketplace solution. Such a marketplace can allow Re* value-chain stakeholders to come together and transact. This could include asset owners, Re* providers (such as remanufacturers), logistics providers, recyclers, OEMs, dealers, or the like. An example of a transaction sequence may comprise: (a) an asset owner uploads data about their ageing asset, (b) the asset recovery platform computes the residual value of the asset and creates a sales listing, (c) the platform then uses algorithms to match the seller with the available buyers, and (d) the platform executes the transactions (after approval) by making payments and enabling transfer of the assets.

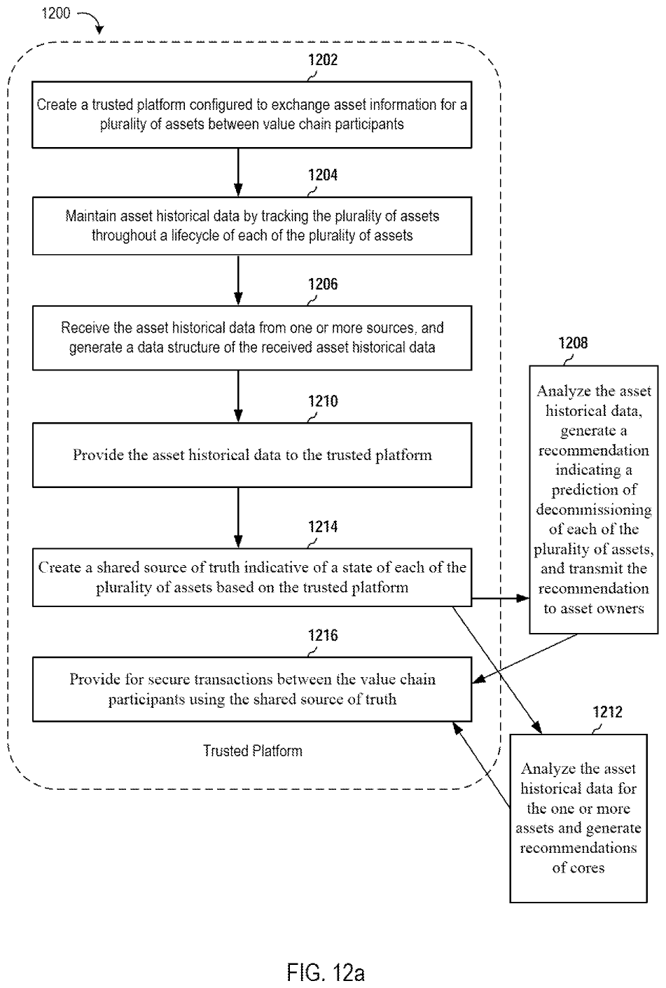

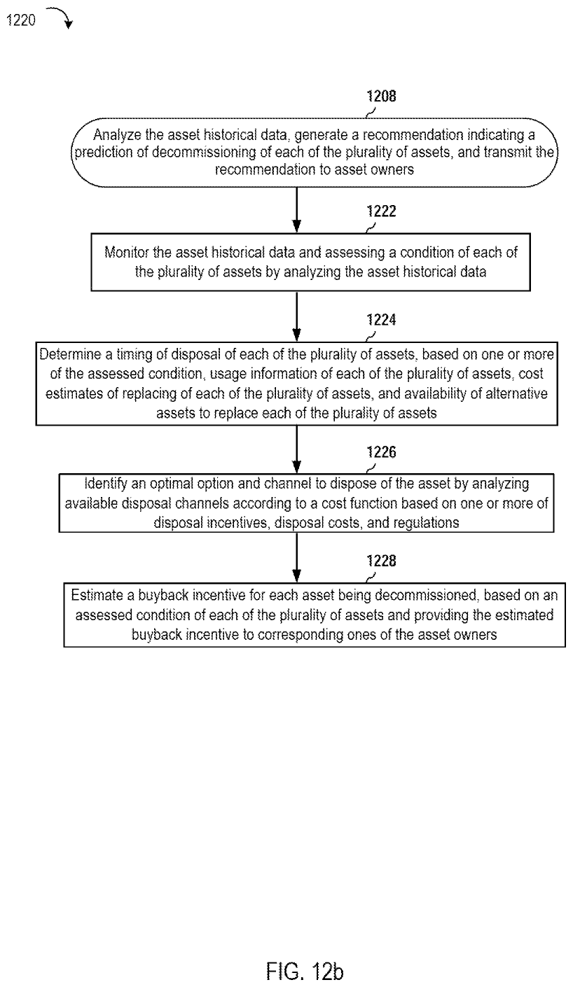

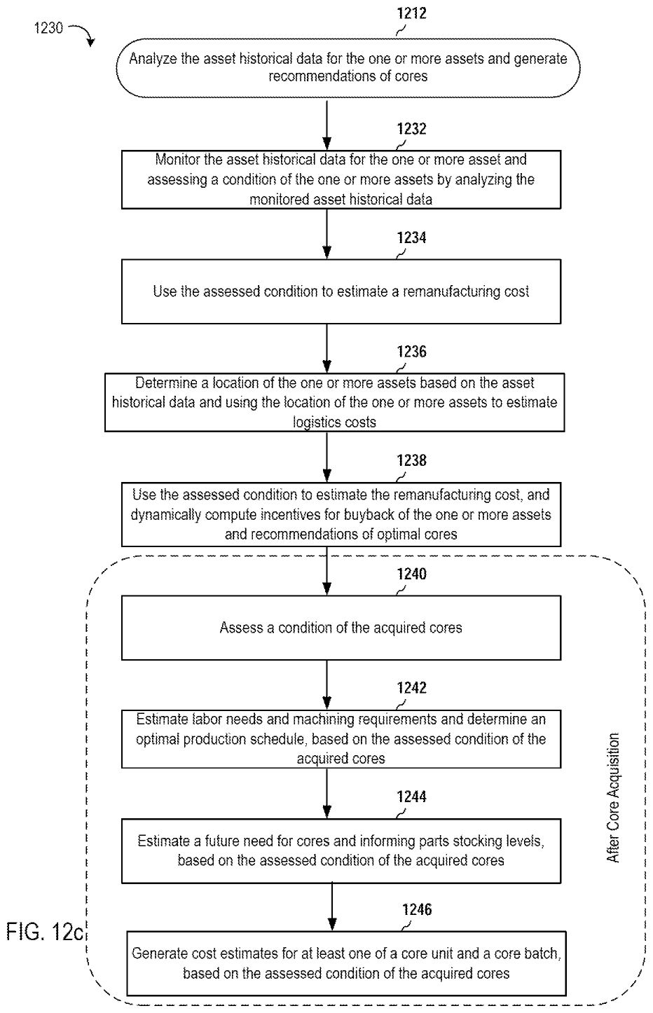

FIGS. 12a to 12c illustrate example flow diagrams that can be executed by the platform. FIG. 12a illustrates an example flow for an asset recovery platform, in accordance with an example implementation. Specifically, FIG. 12a illustrates an example flow for implementing the asset recovery platform in which the flow process from 1202 to 1216 illustrate an example process for implementing the asset recovery procedure with respect to the trusted platform, asset owners and remanufacturers. In example implementations as described herein, the platform may assist asset owners and/or remanufacturers to buy/sell core products.

The flow proceeds with the platform system creates, at 1202, a trusted platform configured to exchange asset information. The trusted platform may exchange asset information for a plurality of assets between value chain participants. The value chain participants may comprise asset owners that are offering the plurality of assets for sale, and remanufactures that are looking to purchase one or more of the plurality of assets available for sale using the platform. The platform maintains, at 1204, asset historical data of the assets by tracking the plurality of assets throughout a lifecycle of each of the plurality of assets. At 1206, the tracking of the plurality of assets throughout the lifecycle of each of the plurality of assets may comprise receiving the asset historical data from one or more sources. The platform may generate a data structure of the received asset historical data. The data structure may comprise information of the asset based on a blockchain or distributed ledger. At 1208, the flow as directed to asset owners may analyze the asset historical data and generate a recommendation indicating a prediction of decommissioning of each of the plurality of assets, where the recommendation is transmitted to the asset owners. At 1210, the platform may provide the asset historical data to the trusted platform. At 1212, for one or more assets of the plurality of assets being in late stages of respective lifecycles, the flow as directed to remanufacturers may analyze the asset historical data for the one or more assets and generating recommendations of cores. At 1214, the platform may create a shared source of truth indicative of a state of each of the plurality of assets. The shared source of truth may be based on the trusted platform. At 1216, the platform may provide for secure transactions between the value chain participants using the shared source of truth.

FIG. 12b illustrates an example flow for analyzing the asset historical data, after the recommendation directed to the prediction of decommissioning each of the plurality of assets have been transmitted to the asset owners, as discussed in 1208 of FIG. 12a and as described with respect to FIGS. 6 and 9. At 1222, the platform may monitor the asset historical data and assess a condition of each of the plurality of assets by analyzing the asset historical data. The condition of each of the plurality of assets may comprise one or more of a remaining life of an asset, a residual value of the asset, or remediation needs of the asset. At 1224, the platform may determine a timing of disposal of each of the plurality of assets for the generation of the recommendation indicating the prediction of decommissioning of each of the plurality of assets. The timing of disposal of each of the plurality of assets may be determined based on one or more of the assessed condition, usage information of each of the plurality of assets, cost estimates of replacing of each of the plurality of assets, or availability of alternative assets to replace each of the plurality of assets. At 1226, for each asset being decommissioned, the platform may identify an optimal option and channel to dispose of the asset. The platform may identify the optimal option and channel to dispose of the asset by analyzing available disposal channels according to a cost function based on one or more of disposal incentives, disposal costs, or regulations. At 1228, the platform may estimate a buyback incentive for each asset being decommissioned. The platform may estimate the buyback incentive based on an assessed condition of each of the plurality of assets. The platform may provide the estimated buyback incentive to corresponding asset owners of the respective assets.

FIG. 12c illustrates an example flow for analyzing the asset historical data for one or more assets of the plurality of assets being in a late stage of respective lifecycles, as discussed in 1212 of FIG. 12a and as described with respect to FIGS. 6 and 10. At 1232, the platform, for buying the cores, may monitor the asset historical data for the one or more asset and assess a condition of the one or more assets by analyzing the monitored asset historical data. The condition of the one or more assets may comprise one or more of a remaining life of the one or more assets, a residual value of the one or more assets, or remediation needs of the one or more assets. At 1234, the platform may use the assessed condition to estimate a remanufacturing cost. At 1236, the platform may determine a location of the one or more assets. The platform may determine the location of the one or more assets based on the asset historical data. The platform may use the location of the one or more assets to estimate logistics costs. At 1238, the platform may use the assessed condition to estimate the remanufacturing cost, and dynamically compute incentives for buyback of the one or more assets. The platform may also determine recommendations of optimal cores using the estimate of the remanufacturing cost, the estimate of the logistics costs, market information and/or core usage requirements. For the flow after the core acquisition, at 1240, the platform may assess a condition of the acquired cores. At 1242, based on the assessed condition of the acquired cores, the platform may estimate labor needs and machining requirements. The platform may also determine an optimal production schedule based on the assessed condition of the acquired cores. At 1244, based on the assessed condition of the acquired cores, the platform may estimate a future need for cores and inform parts stocking levels. At 1246, based on the assessed condition of the acquired cores, the platform may generate cost estimates for at least one of a core unit or a core batch.

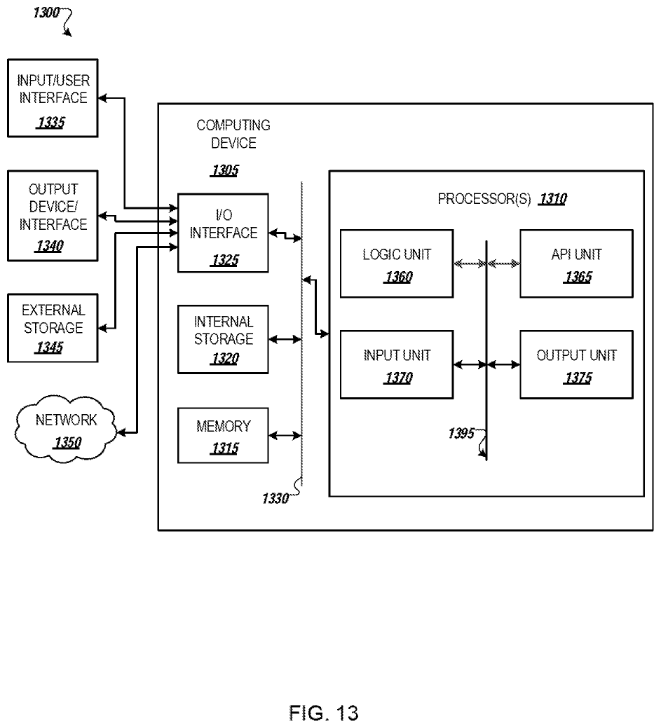

FIG. 13 illustrates an example computing environment with an example computer device suitable for use in some example implementations, such as for facilitating implementation of functionality for the blockchain or distributed ledger of the asset recovery platform as illustrated in FIG. 7, a condition assessment mechanism as illustrated in FIG. 8, an asset decommissioning mechanism as illustrated in FIG. 9, a core-buying mechanism as illustrated in FIG. 10, or a data layer structure as illustrated in FIG. 11.

Computer device 1305 in computing environment 1300 can include one or more processing units, cores, or processors 1310, memory 1315 (e.g., RAM, ROM, and/or the like), internal storage 1320 (e.g., magnetic, optical, solid state storage, and/or organic), and/or I/O interface 1325, any of which can be coupled on a communication mechanism or bus 1330 for communicating information or embedded in the computer device 1305. I/O interface 1325 is also configured to receive images from cameras or provide images to projectors or displays, depending on the desired implementation.

Computer device 1305 can be communicatively coupled to input/user interface 1335 and output device/interface 1340. Either one or both of input/user interface 1335 and output device/interface 1340 can be a wired or wireless interface and can be detachable. Input/user interface 1335 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1340 may include a display, television, monitor, printer, speaker, braille, or the like. In some example implementations, input/user interface 1335 and output device/interface 1340 can be embedded with or physically coupled to the computer device 1305. In other example implementations, other computer devices may function as or provide the functions of input/user interface 1335 and output device/interface 1340 for a computer device 1305.

Examples of computer device 1305 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1305 can be communicatively coupled (e.g., via I/O interface 1325) to external storage 1345 and network 1350 for communicating with any number of networked components, devices, and systems, including one or more computer devices of the same or different configuration. Computer device 1305 or any connected computer device can be functioning as, providing services of, or referred to as a server, client, thin server, general machine, special-purpose machine, or another label.

I/O interface 1325 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1300. Network 1350 can be any network or combination of networks (e.g., the Internet, local area network, wide area network, a telephonic network, a cellular network, satellite network, and the like).

Computer device 1305 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1305 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1310 can execute under any operating system (OS) (not shown), in a native or virtual environment. One or more applications can be deployed that include logic unit 1360, application programming interface (API) unit 1365, input unit 1370, output unit 1375, and inter-unit communication mechanism 1395 for the different units to communicate with each other, with the OS, and with other applications (not shown). The described units and elements can be varied in design, function, configuration, or implementation and are not limited to the descriptions provided.

In some example implementations, when information or an execution instruction is received by API unit 1365, it may be communicated to one or more other units (e.g., logic unit 1360, input unit 1370, output unit 1375). In some instances, logic unit 1360 may be configured to control the information flow among the units and direct the services provided by API unit 1365, input unit 1370, output unit 1375, in some example implementations described above. For example, the flow of one or more processes or implementations may be controlled by logic unit 1360 alone or in conjunction with API unit 1365. The input unit 1370 may be configured to obtain input for the calculations described in the example implementations, and the output unit 1375 may be configured to provide output based on the calculations described in example implementations.

Memory 1315 can be used in conjunction with external storage 1345 to function as the blockchain or distributed ledger of the asset recovery platform as illustrated in FIG. 7, a condition assessment mechanism as illustrated in FIG. 8, an asset decommissioning mechanism as illustrated in FIG. 9, a core-buying mechanism as illustrated in FIG. 10, or a data layer structure as illustrated in FIG. 11.

Processor(s) 1310 can be configured to execute the flow diagrams from FIGS. 12a to 12c and refer to the platform procedures described in at least FIGS. 8-10. In an example implementation, processor(s) 1310 can be configured to create a trusted platform configured to exchange asset information for a plurality of assets between value chain participants; maintain asset historical data by tracking the plurality of assets throughout a lifecycle of each of the plurality of assets; provide the asset historical data to the trusted platform; create a shared source of truth indicative of a state of each of the plurality of assets based on the trusted platform; and provide for secure transactions between the value chain participants using the shared source of truth as described in FIG. 12a.

In an example implementation when processor(s) 1310 are tracking the plurality of assets throughout the lifecycle of each of the plurality of assets, processor(s) 1310 are configured to receive the asset historical data from one or more sources, and generate a data structure of the received asset historical data as described with respect to FIG. 12a.

In an example implementation, processor(s) 1310 can be configured to analyze the asset historical data, generate a recommendation indicating a prediction of decommissioning of each of the plurality of assets, and transmit the recommendation to asset owners as described with respect to FIG. 12a.

In an example implementation, processor(s) 1310 can be configured to, for one or more assets of the plurality of assets being in late stages of respective lifecycles, analyze the asset historical data for the one or more assets and generating recommendations of cores as described with respect to FIG. 12a.

In an example implementation, processor(s) 1310 can be configured to monitor the asset historical data and assessing a condition of each of the plurality of assets by analyzing the asset historical data as described with respect to FIG. 12b.

In an example implementation when processor(s) 1310 is generating the recommendation indicating the prediction of decommissioning of each of the plurality of assets, processor(s) 1310 are configured to determine a timing of disposal of each of the plurality of assets, based on one or more of the assessed condition, usage information of each of the plurality of assets, cost estimates of replacing of each of the plurality of assets, and availability of alternative assets to replace each of the plurality of assets as described with respect to FIG. 12b.

In an example implementation, for each asset being decommissioned, processor(s) 1310 can be configured to identify an optimal option and channel to dispose of the asset by analyzing available disposal channels according to a cost function based on one or more of disposal incentives, disposal costs, and regulations as described with respect to FIG. 12b.

In an example implementation, processor(s) 1310 can be configured to estimate a buyback incentive for each asset being decommissioned, based on an assessed condition of each of the plurality of assets and provide the estimated buyback incentive to corresponding ones of the asset owners as described with respect to FIG. 12b.

In an example implementation, for buying the cores, processor(s) 1310 can be configured to monitor the asset historical data for the one or more asset and assessing a condition of the one or more assets by analyzing the monitored asset historical data as described with respect to FIG. 12c.

In an example implementation, processor(s) 1310 can be configured to use the assessed condition to estimate a remanufacturing cost as described with respect to FIG. 12c.

In an example implementation, processor(s) 1310 can be configured to determine a location of the one or more assets based on the asset historical data and using the location of the one or more assets to estimate logistics costs as described with respect to FIG. 12c.

In an example implementation, processor(s) 1310 can be configured to use the assessed condition to estimate the remanufacturing cost; and dynamically compute incentives for buyback of the one or more assets and recommendations of optimal cores using the estimate of the remanufacturing cost, the estimate of the logistics costs, market information and core usage requirements as described with respect to FIG. 12c.

In an example implementation, for the cores acquired, processor(s) 1310 can be configured to assess a condition of the acquired cores as described with respect to FIG. 12c.

In an example implementation, processor(s) 1310 can be configured to estimate labor needs and machining requirements and determining an optimal production schedule, based on the assessed condition of the acquired cores as described with respect to FIG. 12c.

In an example implementation, processor(s) 1310 can be configured to estimate a future need for cores and informing parts stocking levels, based on the assessed condition of the acquired cores as described with respect to FIG. 12c.

In an example implementation, processor(s) 1310 can be configured to generate cost estimates for at least one of a core unit and a core batch, based on the assessed condition of the acquired cores as described with respect to FIG. 12c.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method comprising:
creating a trusted platform configured to exchange asset information for a plurality of assets between value chain participants;
maintaining asset historical data by tracking the plurality of assets throughout a lifecycle of each of the plurality of assets;
providing the asset historical data to the trusted platform;
creating a shared source of truth indicative of a state of each of the plurality of assets based on the trusted platform; and
providing for secure transactions between the value chain participants using the shared source of truth.

2. The method of claim 1, wherein the plurality of assets comprises one or more of a product and components of the product.

3. The method of claim 1, wherein the tracking the plurality of assets throughout the lifecycle of each of the plurality of assets comprises receiving the asset historical data from one or more sources, and wherein the method further comprises generating a data structure of the received asset historical data.

4. The method of claim 1, further comprising analyzing the asset historical data, generating a recommendation indicating a prediction of decommissioning of each of the plurality of assets, and transmitting the recommendation to asset owners.

5. The method of claim 4, further comprising monitoring the asset historical data and assessing a condition of each of the plurality of assets by analyzing the asset historical data.

6. The method of claim 5, wherein the condition of each of the plurality of assets comprises one or more of a remaining life of an asset, a residual value of the asset, and remediation needs of the asset.

7. The method of claim 5, wherein the generating the recommendation indicating the prediction of decommissioning of each of the plurality of assets comprises determining a timing of disposal of each of the plurality of assets, based on one or more of the assessed condition, usage information of each of the plurality of assets, cost estimates of replacing of each of the plurality of assets, and availability of alternative assets to replace each of the plurality of assets.

8. The method of claim 4, further comprising, for each asset being decommissioned, identifying an optimal option and channel to dispose of the asset by analyzing available disposal channels according to a cost function based on one or more of disposal incentives, disposal costs, and regulations.

9. The method of claim 4, further comprising estimating a buyback incentive for each asset being decommissioned, based on an assessed condition of each of the plurality of assets and providing the estimated buyback incentive to corresponding ones of the asset owners.

10. The method of claim 1, further comprising, for one or more assets of the plurality of assets being in late stages of respective lifecycles, analyzing the asset historical data for the one or more assets and generating recommendations of cores.

11. The method of claim 10, further comprising, for buying the cores, monitoring the asset historical data for the one or more asset and assessing a condition of the one or more assets by analyzing the monitored asset historical data.

12. The method of claim 11, wherein the condition of the one or more assets comprises one or more of a remaining life of the one or more assets, a residual value of the one or more assets, and remediation needs of the one or more assets.

13. The method of claim 11, further comprising using the assessed condition to estimate a remanufacturing cost.

14. The method of claim 13, further comprising determining a location of the one or more assets based on the asset historical data and using the location of the one or more assets to estimate logistics costs.

15. The method of claim 14, further comprising:
using the assessed condition to estimate the remanufacturing cost; and
dynamically computing incentives for buyback of the one or more assets and recommendations of optimal cores using the estimate of the remanufacturing cost, the estimate of the logistics costs, market information and core usage requirements.

16. The method of claim 10, further comprising, for the cores acquired, assessing a condition of the acquired cores.

17. The method of claim 16, further comprising estimating labor needs and machining requirements and determining an optimal production schedule, based on the assessed condition of the acquired cores.

18. The method of claim 16, further comprising estimating a future need for cores and informing parts stocking levels, based on the assessed condition of the acquired cores.

19. The method of claim 16, further comprising generating cost estimates for at least one of a core unit and a core batch, based on the assessed condition of the acquired cores.

20. A system, comprising:
at least one memory configured to store instructions; and
at least one processor coupled to the at least one memory and configured to execute the instructions to:
create a trusted platform configured to exchange asset information for a plurality of assets between value chain participants;
maintain asset historical data by tracking the plurality of assets throughout a lifecycle of each of the plurality of assets;
provide the asset historical data to the trusted platform;
create a shared source of truth indicative of a state of each of the plurality of assets based on the trusted platform; and
provide for secure transactions between the value chain participants using the shared source of truth.
